(19) United States
(12) Patent Application Publication
(10) Pub. No.: US 2023/0020313 A1
(43) Pub. Date: Jan. 19, 2023

(54) DEVICES, SYSTEMS AND METHODS FOR FILTERING LIQUIDS

(71) Applicant: DelStar Technologies, Inc., Middletown, DE (US)

(72) Inventor: Britt Faucette, Decatur, GA (US)

(73) Assignee: DelStar Technologies, Inc., Middletown, DE (US)

(21) Appl. No.: 17/856,975

(22) Filed: Jul. 2, 2022

Related U.S. Application Data
(60) Provisional application No. 63/221,435, filed on Jul. 13, 2021.

(51) Int. Cl. C02F 1/28; C02F 1/00

(52) U.S. Cl. CPC C02F 1/288; C02F 1/004; C02F 1/283; C02F 1/286; C02F 2103/001

(57) ABSTRACT

Devices and methods are provided for filtering contaminants or pollutants from water, such as rainwater or stormwater. The devices include a liquid filter comprising a tubular mesh enclosure containing a filling. The filling comprises compost particles and an activated carbon material. The compost particles have a bulk particle distribution of more than 30% less than 0.375 inches and at least 90% less than 2 inches. This unique combination of particle sizes and filling materials increases the removal efficiency of the filter. In addition, this filter media absorbs a broader range of industrial pollutants than conventional filters.

### CROSS-REFERENCE TO RELATED APPLICATIONS

This application claims the benefit of U.S. Provisional Application Ser. No. 63/221,435, filed Jul. 13, 2021, the complete disclosure of which is incorporated herein by reference in its entirety for all purposes.

### TECHNICAL FIELD

The present invention generally relates to the filtration of contaminants and/or pollutants from liquids and more particularly to devices and methods for filtering contaminants or pollutants from water, such as stormwater.

### BACKGROUND

Stormwater is rainwater plus any particulate debris and dissolved materials that the rainwater captures as it flows along the ground surface. In urban areas, rain that falls on the roofs of buildings or collects on paved areas like driveways, roads, runways and sidewalks is typically diverted through a system of pipes that is separate from the sewerage system. Unlike sewage, however, stormwater historically has not been treated, but flows directly from streets and gutters into natural bodies of water, e.g., rivers, lakes and the ocean.

Stormwater can therefore be a form of diffuse or non-point source pollution. It can entrain pollutants, such as garbage, sediment, organic matter, heavy metals, and organic toxins, and transport them into receiving natural bodies of water. As a consequence, natural bodies of water that receive stormwater may also receive pollutants capable of irreparable environmental harm.

Storm water can carry a substantial amount of pollutants to certain natural bodies of water. About 80% of the population of the United States lives near water where the shore communities create run-off in land areas that have only a mild descent towards the rivers, lakes and oceans. The amount of stormwater pollution entering into such receiving bodies of water is related to the degree of urbanization in the surrounding area and the nature of the surrounding activities. Urbanization results in the covering of land with low/no-permeability structures, such as roadways, parking lots, and rooftops, which both generate large volumes of stormwater and accumulate pollutants. Since these types of surfaces do not allow rainfall to infiltrate, they allow the accumulated pollutants to be carried into stormwater drainage systems.

In an effort to address the environmental problems posed by polluted stormwater, traps and filters for stormwater have been developed. Removal of contaminants by filtration is a commonly used and accepted practice in stormwater applications as a method for capturing fine particles. Filters employ a various array of media that capture particulate matter by bonding or capture. The media is typically granular and is contained in a device or structure that allows media compaction.

One commonly-used type of stormwater filter is formed from a tubular mesh enclosure that includes a filler material to filter contaminants from water passing through the interior of the enclosure. The tubular mesh enclosure is sometimes referred to as a “filter sock”. These mesh enclosures or filter socks may include a large tube that can be sewn or otherwise bonded to form two or more adjacent touching tubes that are filled with absorbent media to mitigate stormwater environmental runoff of sediment, hydrocarbons, nutrients and heavy metals. The filter socks may be placed around top grates of storm drain chambers, and around other environmental runoff sources such as trash bins, roof downspouts, outdoor material stockpiles and the like. The filter socks may be used to mitigate drips and spills of hydrocarbons such as motor oils, may be used to contain nutrients, and may be used to contain zinc, copper, lead, cadmium and other heavy metals.

In one such filter sock, the tubular mesh enclosure is filled with a compost material, such as composted organic materials, mulch, gravel, bark, wood shavings and the like, to absorb or otherwise entrap contaminants within the mesh enclosure. Such a filter is described in U.S. Pat. No. 9,044,795, the complete disclosure of which is incorporated herein by reference for all purposes.

While the compost materials used in existing stormwater filters provide adequate filtration, they suffer from a number of drawbacks. For one, they do not filter out all of the contaminants from stormwater, typically having a suboptimal removal efficiency for many of the contaminants that pass through the filter. In addition, they are substantially ineffective at filtering certain key industrial and municipal stormwater pollutants, such as aluminum, iron, selenium, arsenic, chromium, total nitrogen, ammonium-nitrogen and the like.

What is needed, therefore, are improved devices and methods for filtering contaminants from liquids, such as stormwater. In particular, it would be desirable to provide a filtration media that is more effective at absorbing or capturing contaminants than existing filters and that also filters out a broader range of industrial pollutants.

### SUMMARY

The present disclosure generally relates to the filtration of contaminants from liquids and more particularly to devices and methods for filtering contaminants or pollutants from an influent, such as spring water, stream water, stormwater, outfall water from sewer treatment or drinking water plants, factory or farm discharges, contained contamination discharges, run-off and the like.

In one aspect of the present disclosure, a liquid filter comprises an enclosure containing a filling material. The filling material comprises compost particles and an activated carbon material. The compost particles have a bulk particle distribution of more than 30% less than 0.375 inches and at least 90% less than 2 inches. Applicant has discovered that this unique combination of particle sizes and filling materials filters out a broader range of industrial pollutants and increases the removal efficiency of the filter such that a greater percentage of contaminants/pollutants are captured by the filler material than in conventional filters.

In one embodiment, the enclosure comprises a flexible tube formed from a mesh material. The tube comprises an interior and first and second opposing ends for receiving a liquid, such as stormwater, therethrough. The interior of the tube substantially comprises the filling material such that contaminants/pollutants within the water flowing therethrough are captured, bonded and/or entrained by the filling material as the water passes between the first and second opposing ends.

Certain embodiments of the present disclosure can be used in a variety of ways such as on an erosion-prone slope, across a small drainage ditch or surrounding a drain. The tubes can be held in place by their own weight and/or by stakes, which can be driven through the tubes and into the ground. In certain embodiments, the filter may further comprise additional anchoring mesh attached to the tubes to secure the tubes to the ground.

The bulk particle distribution of the compost particles may be more than 35% less than 0.375 inches. In certain embodiments, the bulk particle distribution may be more than 10% less than 0.25 inches. The bulk particle distribution of the compost particles may be at least 50% greater than 0.375 inches and at least 99% less than 2 inches.

The activated carbon material may comprise charcoal, ash, coal, coke or a combination thereof, preferably charcoal. The compost particles may comprise any decayed organic material, including but not limited to, composted organic materials, organic feedstocks, composted products, mulch, wood shavings, alum, lime, clay, pea gravel, gravel, sand, soil, wood chips, bark, peat, soil blends, straw, hay, leaves, sawdust, paper mill residuals, wood wastes, wood pellets, hemp, bamboo, biosolids, coconut fibers, coir, wheat straw, rice straw, rice hulls, oat straw, soybean hulls, palm wastes, palm leaves, agricultural waste products, manure, wool, hair, sugar cane bagasse, seed hulls, jute, flax, hulls, organic waste, cat litter, plant seeds, plugs, sprigs, and/or spores, fertilizers, flocculants, chemical binders, water absorbers, and the like.

In certain embodiments, the activated carbon material comprises less than about 20% by weight of the filling, preferably about 5% to 15%. Applicant has discovered that having filling material with this particular weight percentage of activated carbon provides improved removal efficiency, absorbs a broader range of industrial pollutants and reduces the overall cost of the filter.

In other embodiments, the activated carbon material comprises greater than about 20% by weight of the filling, or between about 20% to about 50% by weight of the filling. Applicant has discovered that having filling material with this particular range of activated carbon in this range in the filling further improves the overall removal efficiency of the filter.

The compost particles may have an organic matter content of at least 75% by dry weight, preferably at least 90%. The moisture content of the compost may be less than 50% on a % wet weight basis, preferably less than 25% and more preferably less than 20%. In certain embodiments, the moisture content may be between about 15-16% on a % wet weight basis.

In another aspect of the present disclosure, a liquid filter comprises an enclosure containing a filling material. The filling material comprises compost particles and an activated carbon material. The activated carbon material comprises greater than about 20% by weight of the filling, preferably between about 20% and about 50%.

In certain embodiments, the compost particles and the activated carbon material have a bulk particle distribution of more than 30% less than 0.375 inches, preferably more than 35% less than 0.375 inches. The bulk particle distribution may be at least 90% less than 2 inches and more than 10% less than 0.25 inches.

In another aspect of the invention, a stormwater filter comprises a flexible mesh enclosure having first and second ends and an interior. The interior contains a filling comprising compost particles and an activated carbon material. The compost particles and the activated carbon material have a relative weight percentage and a bulk particle distribution configured to filter out at least 90% of contaminants in storm water passing through the interior of the mesh enclosure, preferably at least 95%.

In certain embodiments, the compost particles and the activated carbon material are configured to filter out at least one (preferably substantially all) of the materials selected from the group consisting of: aluminum, iron, selenium, arsenic, chromium, total nitrogen and ammonium-nitrogen.

In certain embodiments, the compost particles and the activated carbon material have a bulk particle distribution of more than 30% less than 0.375 inches, preferably more than 35% is less than 0.375 inches. The bulk particle distribution may be at least 90% less than 2 inches and more than 10% less than 0.25 inches.

The activated carbon material may comprise charcoal, ash, coal, coke or a combination thereof, preferably charcoal. The compost particles may comprise any decayed organic material, such as leaves, manure, bark, grass clippings, brush trimmings, non-animal food scraps, mulch, wood shavings, gravel, straw, hay, sawdust, bamboo, lime, clay, pea gravel, paper mill residuals, wood wastes, wood pellets, hemp, gravel, sand, soil, wood chips, peat, straw, haw, pinebark, wood pellets and the like.

In one embodiment, the enclosure comprises a flexible tube formed from a mesh material. The tube comprises first and second opposing ends for receiving stormwater therethrough. The interior of the tube substantially comprises the filling material such that water flowing therethrough is filtered as it passes between the first and second opposing ends.

### BRIEF DESCRIPTION OF THE DRAWINGS

Certain embodiments of the disclosure will be more readily understood through the following detailed description, with reference to the accompanying drawings, in which:

FIG. 1 is a block diagram of an embodiment of a system and method according to the present disclosure; and

FIG. 2 is a perspective view of a filter according to one embodiment of the present disclosure.

### DETAILED DESCRIPTION

In some embodiments of the present disclosure, a system is provided that can include mesh containers and/or enclosures that are partially or substantially filled with compost particles and an activated carbon material. The mesh enclosures are particularly useful for filtration of contaminants from influents, such as spring water, stream water, stormwater, outfall water from sewer treatment or drinking water plants, factory or farm discharges, contained contamination discharges, run-off and the like. Although the following description is generally related to mesh tubes or “filter socks”, it will be apparent that the present disclosure is not so limited and may include, for example, membrane filters, sheet filters, enclosures containing rechargeable filter cartridges and combinations thereof.

As used herein, the term “tube” means an elongate member having a longitudinal axis and defining a longitudinal cross-section resembling any closed shape such as, for example, a circle, a non-circle such as an oval and/or a polygon such as a triangle, rectangle, square, hexagon and the like.

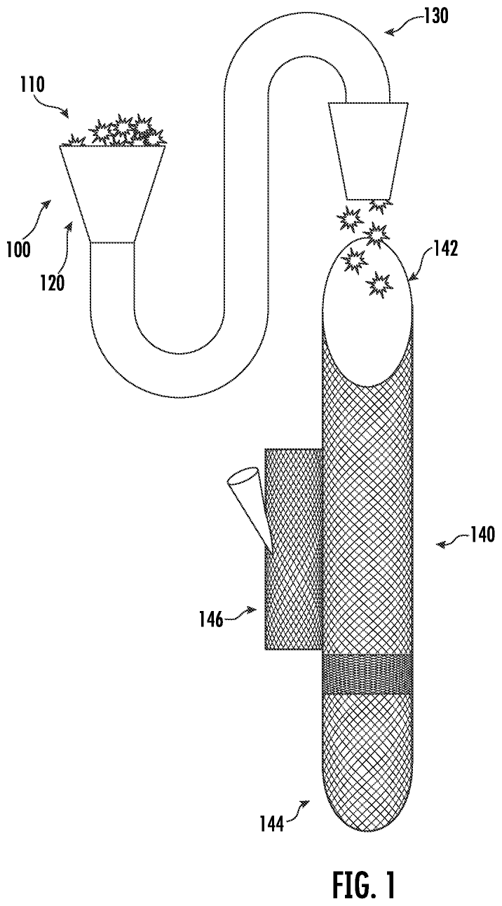

FIG. 1 is a block diagram of an exemplary embodiment of a system 100 which is an exemplary delivery method for delivering a filler material 110. System 100 can include the filler material 110, which can be contained in a storage container 120 and delivered via a delivery mechanism 130 to a mesh container 140.

Storage container 120 can at least partially surround filler material 110, and can be a vessel, tank, hopper, truck, and/or pile, etc. Delivery mechanism 130 can be a hose, tube, pipe, duct, and/or chute, and can include a mechanical and/or pneumatic component, such as an auger, vibrator, and/or fan, etc. for biasing filler material 110 toward and/or into mesh container 140. Moreover, delivery mechanism 130 can be replaced with a manual approach. Delivery mechanism 130 can include a nozzle, reducer, and/or hose adaptor that allows a standard hose (such as a hose having an approximately 4- or 5-inch diameter) to fill a larger and/or smaller diameter mesh containment system.

In some embodiments, mesh container 140 can be unfilled, filled partially, or filled completely. In some embodiments, when filled completely, mesh container 140 can be generally curvilinear, round, oval, or polygonal in longitudinal cross-section. If generally oval, mesh container 140 can have a major diameter ranging from approximately 3 inches to approximately 30 inches.

In some embodiments, mesh container 140 can have opposing ends which may be shut. In one embodiment, the mesh container can take a tubular shape, and the device can have an end nearest the delivery device called the proximal end 142 and an end furthest the delivery device called distal end 144. Distal end 144 can be shut and/or sealed prior to the delivery of filler material 110 into mesh container 140. In some embodiments, the closing of the ends is such that they are irreversibly shut. In other embodiments, the closing of the ends is such that they may be re-opened using an opening and closing mechanism. In one embodiment, proximal end 142 can be shut and/or sealed after delivery of filler material 110 into mesh container 140. The method of closing and/or sealing either of ends 142 and 144 can include knitting, sewing, folding, welding, stapling, clipping, clamping, tying, knotting, and/or fastening, etc.

In some embodiments, attached to mesh container 140 is an anchoring device 146, such as a flap fabricated from mesh netting, such as that used to fabricate mesh container 140. Such a flap can range in dimensions with the size of the tube and/or the expected forces that might bear upon the tube. For example, an 8-inch diameter tube might have two 4-inch-wide flaps that are made from the same mesh material as the tube, and that extend along the entire length of the tube. In some embodiments, stakes can be driven through each of these flaps and into the underlying substrate. This can secure both sides of the tube and can create additional stability for the tube. In other embodiments, anchoring device 146 is anchored using a mechanism other than driving a stake through the mesh, such as for example, tying a string, rope, or cable tie, driving sod stakes, re-bar, or wood stakes through the mesh, hammering an anchor through the mesh, wiring the mesh, etc. It is understood that the anchors may be biodegradable, if so desired.

In some embodiments, the earth surface on which mesh container 140 is placed may be ground, soil, sand, coast, silt, sod, earth, dirt, clay, mud, peat, gravel, rock, asphalt, concrete, pavement, a streambed, a stream bank, a waterway bank, a pond bank, a ditch, a ditch bank, and/or a slope, etc. As an example, a metal or wooden stake could be hammered through a mesh-anchoring device 146 and into a ditch bed to secure a mesh container across the flow path of a ditch to form a “ditch check”. Such a ditch check can slow water flow, encourage the deposition of silt and/or sediment, and/or potentially encourage the growth of plants whose root systems can further discourage run-off and/or erosion.

Filler material 110 comprises compost particles and an activated carbon material. The activated carbon may include charcoal, ash, coal, coke or a combination thereof. In a preferred embodiment, the activated carbon comprises charcoal.

The compost particles may comprise any decayed organic material, such as composted organic materials, organic feedstocks, composted products, mulch, wood shavings, alum, lime, clay, pea gravel, gravel, sand, soil, wood chips, bark, peat, soil blends, straw, hay, leaves, sawdust, paper mill residuals, wood wastes, wood pellets, hemp, bamboo, biosolids, coconut fibers, coir, wheat straw, rice straw, rice hulls, oat straw, soybean hulls, palm wastes, palm leaves, agricultural waste products, manure, wool, hair, sugar cane bagasse, seed hulls, jute, flax, hulls, organic waste, cat litter, plant seeds, plugs, sprigs, and/or spores, fertilizers, flocculants, chemical binders, water absorbers, and the like. The compost may comprise a base material selected from the preceding list, and one or more additives, either selected from the preceding list or separate from such list. Any such additive can be added to and/or blended with the base material prior to, during, and/or after filling of the tube.

Certain embodiments of filling material 110 can provide treatment of stormwater by physically straining and/or entrapping contaminants in the stormwater, biologically treating, chemically binding, remediating, and/or degrading such contaminants.

Filling material 110 may include an array of other materials beyond compost and activated carbon, such as certain plants, such as mustard, flowers, vines, shrubs, grasses, diatomaceous earth, chitin, ground glass, alum, aluminum oxide, alum sludge, iron oxide, iron ore, iron ore waste, ironite, iron sulfate, pumice, perlite, rock fragments, mineral fragments, ion exchange substances, resin, beads, zeolites, plant seeds, plugs, sprigs, spores, mycorrizhae, humic acid, biological stimulants, microorganisms, microflora, rhizospheres, microspheres and/or ecosystems.

For example, certain embodiments of filling material 110 ma include entities, such as colonies, colony forming units, spores, seeds, bulbs, plugs, sprouts, sprigs, and/or seedlings of microorganisms, bacteria, fungi and/or plants. These entities can assist with remediating the environmental impact of the effluent to, for example, attack, break down or inhibit the growth of particular bacterial components.

The particle size of the compost comprises at least 30% passing through a 0.375 inch sieve (on a % dry weight basis), preferably at least 35% passing through a 0.375 inch sieve. At least 50% of the particles are preferably greater than a 0.375 inch sieve. In one exemplary embodiment, about 36-37% of the compost particles pass through a 0.375 inch sieve. In certain embodiments, at least 10% of the compost particles pass through a 0.25 inch sieve, preferably between about 14-15% will pass through a 0.25 inch sieve.

In certain embodiments, at least 90% of the compost particles will pass through a 2-inch sieve, preferably at least 99% passing through a 2-inch sieve. In exemplary embodiments, at least 90% of the compost particles will pass through a 1 inch sieve, preferably at least 99% of the particles. The mean, medium, minimum and/or maximum size of the compost can vary according to the application.

Applicant has discovered that the addition of activated carbon with the compost particles sizes described above allows the filter to substantially absorb (i.e., filter out of the water) a broad range of contaminants/pollutants, including but not limited to hydrocarbons and/or organic chemicals (such as 2,4,6-trinitrotoluene), nutrients (such as fertilizer, nitrates, phosphates, sewage, and/or animal waste), pathogens (e.g., bacteria, protozoa, parasites, viruses and/or prions) and/or metals, such as aluminum, iron, selenium, arsenic, antimony, silicone, chromium, total nitrogen and ammonium-nitrogen, ammonia, nitrate, organic nitrogen, phosphorus, potassium, calcium, magnesium, sulfate, cadmium, cobalt, copper, iron, lead, manganese, mercury, molybdenum, nickel, zinc and boron. In particular, Applicant notes that previous filtering devices, such as the one described above in U.S. Pat. No. 9,044,795, are unable to substantially filter certain pollutants, such as at least aluminum, iron, selenium, arsenic, chromium, total nitrogen and ammonium-nitrogen.

In some embodiments, the activated carbon material comprises less than about 20% by weight of the filling, preferably about 5% to about 15%. Applicant has also discovered that having activated carbon in this range in the filling provides improved removal efficiency, absorbs a broader range of industrial pollutants and reduces the overall cost of the filter.

In other embodiments, the activated carbon material comprises greater than about 20% by weight of the filling, or between about 20% to about 50% by weight of the filling. Applicant has discovered that having activated carbon in this range in the filling further improves the overall removal efficiency of the filling material.

The compost may be weed seed-free, disease-free, and/or insect free, and can be derived from a well-decomposed source of organic matter. In certain embodiments, the compost can have a pH between about 5.0 and about 8.0, preferably about 7.5.

The moisture content of the compost may be less than 50% on a % wet weight basis, preferably less than 25% and more preferably less than 20%. In certain embodiments, the moisture content may be between about 15-16% on a % wet weight basis. The organic matter content may be at least 75% of the compost on a % dry weight basis, preferably greater than about 90%.

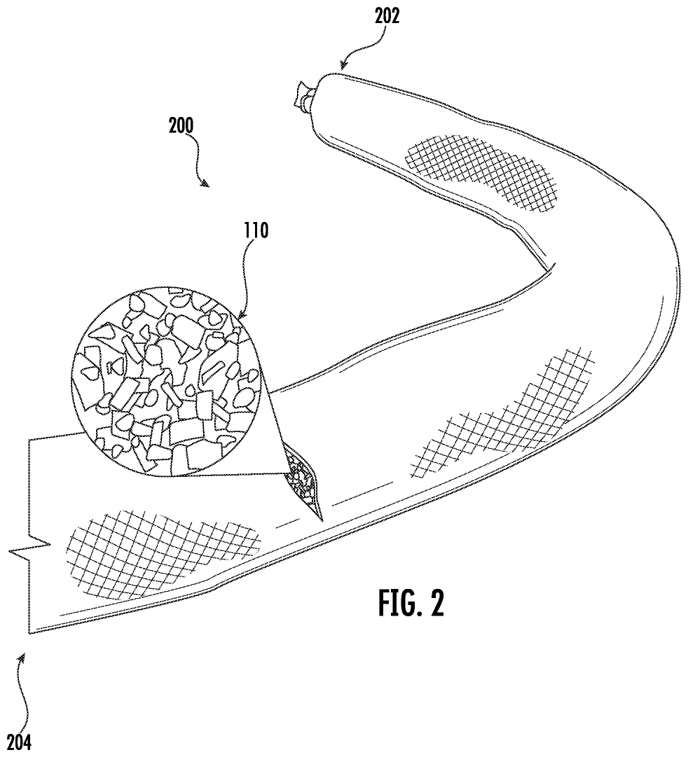

Referring now to FIG. 2, a tubular enclosure 200 according to the present invention comprises an outer mesh material having first and second open ends 202, 204. One of the open ends 202, 204 can be closed and/or sealed prior to delivery of filling material 110 into enclosure 200. After delivery of filling, the other end may be closed or sealed. The method of closing and/or sealing either of ends 202, 204 can include knitting, sewing, folding, welding, stapling, clipping, clamping, tying, knotting and/or fastening.

The mesh material can be fabricated from a flexible netting material, which can be woven, sewn, knitted, welded, molded, and/or extruded, etc. The mesh material can be biodegradable, such as cotton, a natural fiber, UV-sensitive plastic, and/or biodegradable polymer, such as a plastic and/or starch.

In certain embodiments, the mesh material can be selected to biodegrade within about 1 month to about 3 years, including every value therebetween. Alternatively, the netting material can resist biodegradation. The mesh material can be fabricated from plastic, UV-inhibited plastic, polyester, polypropylene, polyethylene, LDPE, HDPE, rayon and/or nylon.

The mesh material can be any diameter and/or thickness, ranging from approximately 0.5 to 30 mils. The mesh material can be in any available mesh size (mesh opening) from about 0.0001 to about 1.5 inches. The mesh material can have any mesh opening pattern, including diamond, hexagonal, oval, round and/or square. Mesh enclosure 200 may have a major cross-section width ranging from about 3 inches to about 30 inches. The diameter or height may be about 8 inches, or about 12 inches.

The tubular enclosure 200 can be fabricated in standard lengths, such as between about 1 to about 500 feet or longer. Any number of enclosures 200 can be coupled together in a process called “sleeving” to form a continuous mesh tube of any size. Thus, certain lengths of mesh enclosures 200 can be intended to be portable, and other lengths can be intended to be immobile.

Tubular enclosure 200 can be filled with filling material 110 completely or incompletely. When filled completely, a longitudinal cross-section of enclosure 200 can be generally curvilinear in shape, such as a circle or a non-circle, oval, D-shaped, polygon, such as a triangle, rectangle, square, hexagon or the like. In certain embodiments, tubular enclosure 200 may have a substantially flat side (e.g., D-shaped) such that the substantially flat side may be positioned adjacent a surface supporting enclosure 200, thereby preventing rolling, sliding or other dislocation of enclosure 200 relative to its support surface.

The filter system of the present invention may further include one or more anchoring devices (not shown), such as stakes or other similar devices. Enclosure 200 may further include flaps or other projections for allowing stakes to be driven therethrough to anchor enclosure 200 to a support surface. Alternatively, the anchoring device may include a string, rope, cable tie, sod stakes, re-bar, wood stakes and/or wire attached to mesh enclosure 200.

### EXAMPLE

To determine the contaminant removal efficiency of liquid filters according to the present disclosure, applicant tested filter socks comprising a tubular mesh enclosure as described above with filler material comprising compost particles and an activated carbon material. The tubular mesh enclosures had a height or diameter of about 8 inches or about 12 inches. The bulk particle size distribution of the filler material was as follows: (1) 100% less than 25 mm or about 0.984 inches; (2) 76.3 percent less than 16 mm or about 0.63 inches; (3) 36.3% less than 9.5 mm or 0.375 inches; (3) 14.7% less than 6.3 mm or 0.25 inches; (4) 4.2% less than 4.0 mm or about 0.16 inches; and (5) 2.2% less than 2.0 mm or about 0.078 inches. The particles sizes were tested with TMECC Test Method 02.02-B Sample Sieving for Aggregate Size Classification).

The filter was placed on hill with a slope of about 3:1 (H:V) on sandy clay soil (49% sand, 13% silt, 38% clay: USDA classification). The overall plot size was about 27 feet long and 8 feet wide. Rainfall was tested at 2 in/hr, 4 in/hr and 6 in/hr for 20 minute durations each or a total of 60 minutes of rainfall. The test was performed under Modified ASTM D-6459:Standard Test Method for Determination of Rolled Erosion Control Product (RECP) Performance in Protecting Hillslopes from Rainfall-Induced Erosion.

Applicant discovered through these results that the filter of the present disclosure had an improved removal efficiency for most pollutants and contaminants that passed through the filter. In addition, Applicant discovered that the filter of the present disclosure substantially absorbed (i.e., filtered out of the water) a broad range of contaminants/pollutants, including but not limited to aluminum, iron, selenium, arsenic, chromium, total nitrogen and ammonium-nitrogen, ammonia, nitrate, organic nitrogen, phosphorus, potassium, calcium, magnesium, sulfate, cadmium, cobalt, copper, iron, lead, manganese, mercury, molybdenum, nickel, zinc and boron.

The pH of the filling material was 7.49 (TMECC Test Method 04.11-A 1:5 Slurry pH). The moisture content was 15.7 measured on a percentage dry weight basis (TMECC Test Method 3.09-A-Total Solids and Moisture). The organic matter content was 91.3 measured on a percentage dry weight basis (TMECC Test Method 05.07-A Loss-on-Ignition Organic Matter Method (LOI). The stability indicator was 1.1 mg CO2-C/gOM/day (TMECC Test Method 05.08-B Carbon Dioxide Evolution Rate). The Soluble Salts 3.0 dS/m (mmhos/cm) measured under TMECC Test Method 04.10-A 1:5 Slurry Method Mass Basis.

While the invention has been described in detail herein in accordance with certain preferred embodiments thereof, many modifications and changes therein may be effected by those skilled in the art. Accordingly, the foregoing disclosure should not be construed to be limited thereby but should be construed to include such aforementioned obvious variations and be limited only by the spirit and scope of the following claims.

For example, in a first aspect, a first embodiment is a filter comprising an enclosure containing a filling. The filling comprises compost particles and an activated carbon material. The compost particles have a bulk particle distribution of more than 30% less than 0.375 inches and at least 90% less than 2 inches.

A second embodiment comprises the first embodiment, wherein the activated carbon material comprises greater than about 20% by weight of the filling.

A 3^{rd} embodiment is any one of the first 2 embodiments, wherein the activated carbon material comprises between about 20% to about 50% by weight of the filling.

A 4^{th} embodiment is any one of the first 3 embodiments wherein the activated carbon material comprises less than about 20% by weight of the filling.

A 5^{th} embodiment is any one of the first 4 embodiments, wherein the activated carbon material comprises charcoal.

A 6^{th} embodiment is any one of the first 5 embodiments, wherein the bulk particle distribution is more than 35% less than 0.375 inches.

A 7^{th} embodiment is any one of the first 6 embodiments, wherein the bulk particle distribution is at least 50% more than 0.375 inches.

An 8^{th} embodiment is any one of the first 7 embodiments, wherein the bulk particle distribution is more than 10% less than 0.25 inches.

A 9^{th} embodiment is any one of the first 8 embodiments, the bulk particle distribution is at least 99% less than 2 inches.

A 10^{th} embodiment is any one of the first 9 embodiments, wherein the bulk particle distribution is at least 50% greater than about 0.375 inches.

An 11^{th} embodiment is any one of the first 10 embodiments, wherein the enclosure comprises a flexible tube formed from a mesh material.

A 12^{th} embodiment is any one of the first 11 embodiments, wherein the tube comprises first and second opposing ends for receiving stormwater therethrough.

A 13^{th} embodiment is any one of the first 12 embodiments, wherein the compost particles have an organic matter content of at least 90% by dry weight.

A 14^{th} embodiment is any one of the first 13 embodiments, wherein the compost particles have a moisture content of about 10% to about 20% by wet weight.

In a second aspect a first embodiment is a water filter comprising an enclosure containing a filling. The filling comprises compost particles and an activated carbon material. The activated carbon material comprises greater than about 20% by weight of the filling.

A second embodiment comprises the first embodiment, wherein the activated carbon material comprises between about 20% to about 50% by weight of the filling.

A 3^{rd} embodiment is any one of the first 2 embodiments, wherein the compost particles and the activated carbon material have a bulk particle distribution of more than 30% less than 0.375 inches and at least 90% less than 2 inches

A 4^{th} embodiment is any one of the first 3 embodiments, wherein the bulk particle distribution is more than 10% less than 0.25 inches.

A 5^{th} embodiment is any one of the first 4 embodiments, wherein the bulk particle distribution is more than 35% less than 0.375 inches.

A 6^{th} embodiment is any one of the first 5 embodiments, wherein the activated carbon material comprises charcoal, ash, coal, coke or a combination thereof.

A 5^{7h} embodiment is any one of the first 6 embodiments, wherein the bulk particle distribution is at least 99% less than 2 inches.

An 8^{th} embodiment is any one of the first 7 embodiments, wherein the enclosure comprises a flexible tube formed from a mesh material.

A 9^{th} embodiment is any one of the first 8 embodiments, wherein the tube comprises first and second opposing ends for receiving stormwater therethrough.

In a third aspect, a first embodiment is a stormwater filter comprising a mesh enclosure having first and second ends and an interior. The interior contains a filling. The filling comprises compost particles and an activated carbon material. The compost particles and the activated carbon material have a relative weight percentage and a bulk particle distribution configured to filter out at least 90% of contaminants in storm water passing through the interior of the mesh enclosure.

A second embodiment comprises the first embodiment, wherein the compost particles and the activated carbon material have a relative weight percentage and a bulk particle distribution configured to filter out at least 95% of the contaminants in storm water passing through the interior of the mesh enclosure.

A 3^{rd} embodiment is any one of the first 2 embodiments, wherein the compost particles and the activated carbon material are configured to filter out at least one of the materials selected from the group consisting of: aluminum, iron, selenium, arsenic, chromium, total nitrogen and ammonium-nitrogen.

A 4^{th} embodiment is any one of the first 3 embodiments, wherein the compost particles have a bulk particle distribution of more than 30% greater than 0.375 inches and at least 90% less than 2 inches.

A 5^{th} embodiment is any one of the first 4 embodiments, wherein the activated carbon material comprises charcoal, ash, coal, coke or a combination thereof.

A 6^{th} embodiment is any one of the first 5 embodiments, wherein the bulk particle distribution is more than 35% less than 0.375 inches.

A 7^{th} embodiment is any one of the first 6 embodiments, wherein the bulk particle distribution is more than 10% less than 0.25 inches.

An 8^{th} embodiment is any one of the first 7 embodiments, wherein the bulk particle distribution is at least 99% less than 2 inches.

What is claimed is:

1. A filter comprising:
an enclosure containing a filling;
wherein the filling comprises compost particles and an activated carbon material; and
wherein the compost particles have a bulk particle distribution of more than 30% less than 0.375 inches and at least 90% less than 2 inches.

2. The filter of claim 1, wherein the activated carbon material comprises greater than about 20% by weight of the filling.

3. The filter of claim 1, wherein the activated carbon material comprises between about 20% to about 50% by weight of the filling.

4. The filter of claim 1, wherein the activated carbon material comprises less than about 20% by weight of the filling.

5. The filter of claim 1, wherein the activated carbon material comprises charcoal, ash, coal, coke or a combination thereof.

6. The filter of claim 1, wherein the bulk particle distribution is more than 35% less than 0.375 inches.

7. The filter of claim 1, wherein the bulk particle distribution is at least 50% more than 0.375 inches.

8. The water filter of claim 1, wherein the bulk particle distribution is more than 10% less than 0.25 inches.

9. The water filter of claim 1, wherein the bulk particle distribution is at least 99% less than 2 inches.

10. The water filter of claim 1, wherein the enclosure comprises a flexible tube formed from a mesh material, wherein the tube comprises first and second opposing ends for receiving stormwater therethrough.

11. The water filter of claim 1, wherein the compost particles have an organic matter content of at least 90% by dry weight and a moisture content of about 10% to about 20% by wet weight.

12. A water filter comprising:
an enclosure containing a filling;
wherein the filling comprises compost particles and an activated carbon material; and
wherein the activated carbon material comprises greater than about 20% by weight of the filling.

13. The water filter of claim 12, wherein the activated carbon material comprises between about 20% to about 50% by weight of the filling.

14. The water filter of claim 12, wherein the compost particles and the activated carbon material have a bulk particle distribution of more than 30% less than 0.375 inches and at least 90% less than 2 inches.

15. The water filter of claim 14, wherein the bulk particle distribution is more than 10% less than 0.25 inches.

16. The water filter of claim 14, wherein the bulk particle distribution is more than 35% less than 0.375 inches.

17. The water filter of claim 12, wherein the activated carbon material comprises charcoal, ash, coal, coke or a combination thereof.

18. The water filter of claim 14, wherein the bulk particle distribution is at least 99% less than 2 inches.

19. A stormwater filter comprising:
a mesh enclosure having first and second ends and an interior, wherein the interior contains a filling, wherein the filling comprises
compost particles and an activated carbon material; and
wherein the compost particles and the activated carbon material have a relative weight percentage and a bulk particle distribution configured to filter out at least 90% of contaminants in storm water passing through the interior of the mesh enclosure.

20. The stormwater filter of claim 19, wherein the compost particles and the activated carbon material have a relative weight percentage and a bulk particle distribution configured to filter out at least 95% of the contaminants in storm water passing through the interior of the mesh enclosure.

21. The stormwater filter of claim 19, wherein the compost particles and the activated carbon material are configured to filter out at least one of the materials selected from the group consisting of: aluminum, iron, selenium, arsenic, chromium, total nitrogen and ammonium-nitrogen.

22. The stormwater filter of claim 19, wherein the compost particles have a bulk particle distribution of more than 30% greater than 0.375 inches and at least 90% less than 2 inches.

23. The stormwater filter of claim 19, wherein the activated carbon material comprises charcoal, ash, coal, coke or a combination thereof.

24. The stormwater filter of claim 22, wherein the bulk particle distribution is more than 35% less than 0.375 inches.

25. The stormwater filter of claim 22, wherein the bulk particle distribution is more than 10% less than 0.25 inches.

26. The stormwater filter of claim 22, wherein the bulk particle distribution is at least 99% less than 2 inches.
